(19) United States
(12) Patent Application Publication
(10) Pub. No.: US 2026/0323450 A1
(43) Pub. Date: Oct. 15, 2026

(54) METHOD AND APPARATUS FOR MOBILITY MANAGEMENT

(71) Applicant: 1FINITY Inc., Kawasaki-shi (JP)

(72) Inventor: Tingting GENG, Beijing (CN)

(73) Assignee: 1FINITY Inc., Kawasaki-shi (JP)

(21) Appl. No.: 19/691,919

(22) Filed: May 29, 2026

Related U.S. Application Data
(63) Continuation of application No. PCT/CN2023/139167, filed on Dec. 15, 2023.

(51) Int. Cl. H04W 36/08; H04W 36/00; H04W 36/32

(52) U.S. Cl. CPC H04W 36/087; H04W 36/0079; H04W 36/00835; H04W 36/324

(57) ABSTRACT

An apparatus for mobility management, configured in a first network device CU (Central Unit), includes: processor circuitry configured to determine a second network device DU (Distributed Unit) corresponding to a first report according to the obtained first report, the second network device DU being a network device DU to which a previous serving cell belongs; and a transmitter configured to transmit the first report to the second network device DU via access and mobility indication message.

### CROSS-REFERENCE TO RELATED APPLICATION

This application is a continuation application under 35 U.S.C. 111(a) of International Patent Application PCT/CN2023/139167 filed on Dec. 15, 2023, and designated the U.S., the entire contents of which are incorporated herein by reference.

### TECHNICAL FIELD

Embodiments of the present disclosure relate to the technical field of communications.

### BACKGROUND

Mobility scenarios in radio communication systems include a lower layer triggered mobility (also called L1/L2 triggered mobility (LTM)) scenario. In LTM, a network device transmits configuration information of an LTM candidate cell to a terminal equipment, and the terminal equipment performs downlink and/or uplink synchronization procedures with the LTM candidate cell. The terminal equipment performs L1 measurement and transmits an L1 measurement result corresponding to the LTM candidate cell to the network device. The network device determines an LTM target cell having LTM cell switch for the terminal equipment according to the L1 measurement result, and transmits the LTM target cell having LTM cell switch to the terminal equipment via L₂ signaling. Correspondingly, the terminal equipment performs an LTM cell switch procedure to the LTM target cell. In LTM, the network device notifies the terminal equipment to perform serving cell change via L1/L2 signaling, so as to reduce latency, overhead, and interruption time.

In a distributed architecture, an access network device may be divided into a centralized unit (CU) and a distributed unit (DU). In one possible implementation, one CU may manage a plurality of DUs. In an LTM procedure under a CU-DU architecture, a DU transmits L2 signaling, such as an LTM cell switch message, to a terminal equipment, such that the terminal equipment moves from a coverage area of a serving cell to a coverage area of an LTM target cell. The serving cell and the LTM target cell belong to the same CU, and may belong to the same DU or may belong to different DUs.

It should be noted that the above introduction to the technical background is just to facilitate a clear and complete description of technical solutions of the present disclosure, and is elaborated to facilitate understanding of persons skilled in the art. It cannot be considered that the technical solutions are known by persons skilled in the art just because these solutions are elaborated in Background of the present disclosure.

### SUMMARY

Inventors find that during LTM, if a connection failure occurs, it is needed to consider optimizing LTM-related configurations for subsequent mobility management. The connection failure includes a radio link failure (RLF), a handover failure (HOF), or a connection failure between a terminal equipment and a current serving cell caused by timer expiry or other causes.

Currently, self-organization networks (SONs) introduce network optimization-related mechanisms, including a mobility robustness optimization (MRO) mechanism. In existing MRO mechanisms, by recording parameters in a mobility procedure, generating a corresponding mobility report, and reporting it to a network device, by a terminal equipment, so that the network device may better adjust parameters related to mobility.

The mobility report may include at least one of the following reports: a failure report, a successful mobility report, a random access report (RA report), a connection establishment failure report (CEF report), or other reports. The failure report includes any one or more of a radio link failure report (RLF report) or other failure reports, and the successful mobility report includes various successful mobility reports, such as any one or more of a successful handover report, a successful secondary cell addition or switch report, or other successful reports.

However, for a case where a network device Distributed Unit (DU) performs mobility operations in an LTM scenario, existing mobility reports are only transmitted to a network device Centralized Unit (CU) or a base station, resulting in that a network device DU that performs mobility operations is unable to obtain a required LTM mobility report. In addition, an LTM mobility operation may occur between one or more network device DUs under one network device CU. According to current technologies, a receiving network device only transmits an LTM-related mobility report to a network device CU, resulting in that a network device DU that performs mobility operations is unable to obtain a required LTM mobility report.

For at least one of the above problems or other similar problems, embodiments of the present disclosure provide a method and an apparatus for mobility management.

According to an aspect of embodiments of the present disclosure, an apparatus for mobility management is provided, configured in a first network device CU, wherein the apparatus includes:
a determining unit configured to determine a second network device DU corresponding to a first report according to the received first report; and
a transmitting unit configured to transmit the first report to the second network device DU;
wherein the second network device DU is a device under the first network device CU.

According to another aspect of embodiments of the present disclosure, an apparatus for mobility management is provided, configured in a third network device, wherein the apparatus includes:
a determining unit configured to determine cell information that needs to forward a first report according to the received first report; and
a transmitting unit configured to transmit the first report, and the cell information for forwarding to a first network device CU.

According to a further aspect of embodiments of the present disclosure, an apparatus for mobility management is provided, configured in a first network device CU, wherein the apparatus includes:
a receiving unit configured to receive a first report, and cell information for forwarding corresponding to the first report; and
a transmitting unit configured to transmit the first report to a second network device to which the cell information for forwarding belongs, according to the cell information for forwarding.

One of advantageous effects of embodiments of the present disclosure lies in that according to embodiments of the present disclosure, under a CU-DU architecture, after receiving a first report, a network device CU may forward the first report to a corresponding network device DU, so that the network device DU may perform corresponding parameter adjustments according to the first report, thereby LTM robustness is improved.

Referring to later descriptions and drawings, specific implementations of the present disclosure are disclosed in detail, indicating modes in which principles of the present disclosure may be adopted. It should be understood that implementations of the present disclosure are not limited in scope thereby. Within spirits and scopes of terms of attached claims, implementations of the present disclosure include many changes, modifications, and equivalents.

Feature(s) described and/or shown for one implementation may be used in one or more other implementations in the same way or in a similar way, and may be combined with or replace feature(s) in other implementations.

It should be emphasized that term “include/contain” when being used herein refers to presence of a feature, a whole piece, a step, or a component, but does not exclude presence or addition of one or more other features, whole pieces, steps, or components.

### BRIEF DESCRIPTION OF DRAWINGS

Element(s) and feature(s) described in one drawing or one implementation of embodiments of the present disclosure may be combined with element(s) and feature(s) shown in one or more other drawings or implementations. In addition, in the drawings, similar reference signs denote corresponding components in several drawings, and may be used to indicate corresponding components used in more than one implementation.

FIG. 1 is a schematic diagram of an L1/L2-based inter-cell mobility scenario;

FIG. 2 is a schematic diagram of a forwarding process of an RLF report between network devices;

FIG. 3 is a schematic diagram of a method for mobility management in embodiments of a first aspect of the present disclosure;

FIG. 4 is a schematic diagram of a forwarding process of a first report according to a method in embodiments of the present disclosure;

FIG. 5 is another schematic diagram of a forwarding process of a first report according to a method in embodiments of the present disclosure;

FIG. 6 is a schematic diagram of a method for mobility management in embodiments of a second aspect of the present disclosure;

FIG. 7 is another schematic diagram of a method for mobility management in embodiments of a second aspect of the present disclosure;

FIG. 8 is a schematic diagram of a forwarding process of a first report according to a method in embodiments of the present disclosure;

FIG. 9 is a schematic diagram of an apparatus for mobility management in embodiments of a third aspect of the present disclosure;

FIG. 10 is a schematic diagram of an apparatus for mobility management in embodiments of a fourth aspect of the present disclosure;

FIG. 11 is another schematic diagram of an apparatus for mobility management in embodiments of a fourth aspect of the present disclosure;

FIG. 12 is a schematic diagram of a communication system in embodiments of the present disclosure;

FIG. 13 is a schematic diagram of composition of a network device in embodiments of the present disclosure.

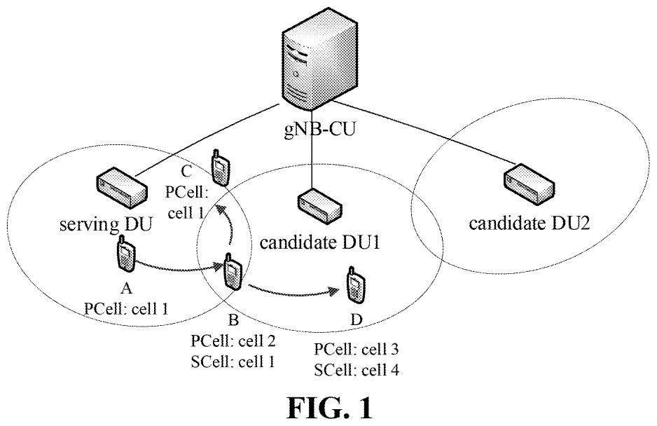

### DETAILED DESCRIPTION

Referring to the drawings, through the following Specification, the aforementioned and other features in the present disclosure will become obvious. Specification and the drawings specifically disclose specific implementations of the present disclosure, indicating partial implementations for which principles of the present disclosure may be adopted. It should be understood that the present disclosure is not limited to described implementations, on the contrary, the present disclosure includes all modifications, variations and equivalents falling within scopes of attached claims.

In embodiments of the present disclosure, terms “first” and “second”, etc. are used to distinguish different elements in terms of appellation, but do not represent a spatial arrangement or time sequence, etc. of these elements, and these elements should not be limited by these terms. Term “and/or” includes any one of and all combinations of one or more of terms listed in an associated manner. Terms “contain”, “include” and “have”, etc. refer to presence of stated feature(s), element(s), component(s), or assembly/assemblies, but do not exclude presence or addition of one or more other features, elements, components, or assemblies.

In embodiments of the present disclosure, singular forms “a/an” and “the”, etc. include plural forms, and should be understood broadly as “a kind of” or “a type of”, but are not defined as the meaning of “one”, in addition, term “the” should be understood to include both singular forms and plural forms, unless a context clearly indicates otherwise. In addition, term “according to” should be understood as “at least partially according to . . . ”, and term “based on” should be understood as “at least partially based on . . . ”, unless a context clearly indicates otherwise.

In embodiments of the present disclosure, scenarios containing a network device and/or a terminal equipment are taken as examples.

In the above scenarios, the network device may include at least one of a core network device, a third-party application device, an operation administration and maintenance (OAM) device, or an access network device.

The core network device may refer to a device in a core network (CN) that provides service support for terminal equipments. As some instances, a core network device may be at least one of the following: a mobility and management entity (MME), an access and mobility management function (AMF) entity, a session management function (SMF) entity, a user plane function (UPF) entity, a Location Management Function (LMF) entity, etc., which are not exhaustively listed here. The AMF entity may be responsible for access management and mobility management of terminals, the SMF entity may be responsible for session management, such as session establishment of a user, and the UPF entity may be a functional entity of a user plane and is primarily responsible for connecting to external networks. The LMF entity may manage overall coordination and scheduling of resources required for positions of terminal equipments registered with or accessing a core network device. It should be noted that in embodiments of the present disclosure, the entity may also be called a network element or a functional entity. For example, the AMF entity may also be called an AMF network element or an AMF functional entity, and so on.

The third-party application device may be an OTT server (over the top server) or other third-party device.

The OAM device may be a network device that performs management work such as operation, administration, and maintenance, etc. on a network according to actual needs of an operator's network operations.

The access network device is an access device through which a terminal equipment wirelessly accesses a communication system. The access network device may be a base station (BS), an evolved NodeB (eNodeB), a transmission reception point (TRP), a base station (next generation NodeB, gNB) in a 5th generation (5G) mobile communication system, a base station in a 6th generation (6G) mobile communication system, a base station in a future mobile communication system or an access node in a WiFi system, etc. The access network device may further be a module or unit that completes part of functions of a base station, for example, may be at least one of the following modules or units: a central unit (CU), a distributed unit (DU), a central unit control plane (CU-CP), a central unit user plane (CU-UP), an Integrated Access Backhaul (IAB), or other module or unit. Embodiments of the present disclosure do not define specific technologies and/or specific device forms adopted by the access network device. The access network device may be deployed on land, including indoors/outdoors, and may be handheld or vehicle-mounted, or may further be deployed on water surfaces, on planes, balloons, or satellites. The access network device may be deployed in a fixed position or on a mobile carrier. Embodiments of the present disclosure do not define in this regard.

In the above scenarios, the terminal equipment may be a device having a wireless transceiving function, may transmit signals to the access network device and/or receive signals from the access network device. The terminal equipment may also be called a terminal, a mobile station, or a mobile terminal, etc. The terminal equipment may be a mobile phone, a tablet, or other device having a wireless smart transceiving function. The terminal equipment may be widely applied in various scenarios, such as device-to-device (D2D), vehicle-to-everything (V2X) communication, machine-type communication (MTC), Internet of Things (IoT), virtual reality, augmented reality, industrial control, autonomous driving, telemedicine, or various smart scenarios.

In the above scenarios, communication between an access network device and a terminal equipment and communication between terminal equipments may be performed via licensed spectrum, or via license-free spectrum, or via both licensed spectrum and license-free spectrum simultaneously. Embodiments of the present disclosure do not define spectrum resources used for wireless communications.

Descriptions are made below by taking that a terminal equipment experiences a connection failure in a current serving cell and a mobility report is an RLF report as an example.

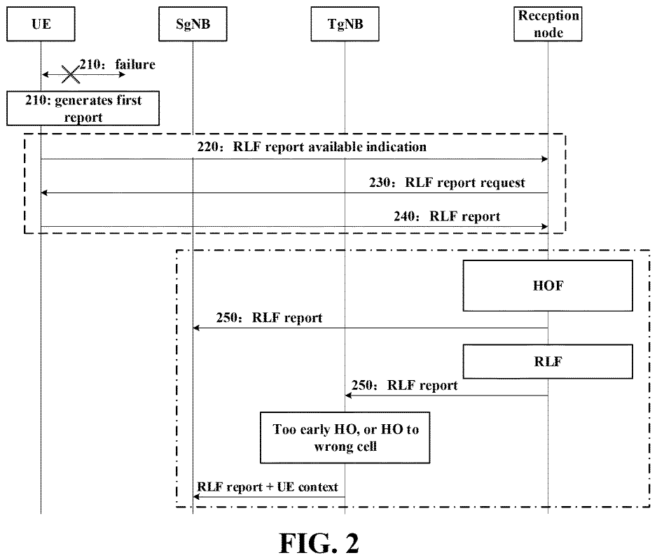

In this example, the terminal equipment may record relevant information into the RLF report, generate and transmit the RLF report. FIG. 2 is a schematic diagram of a forwarding process of the RLF report between network devices. As shown in FIG. 2, the forwarding process may include:
210: a terminal equipment detects that a connection failure occurs in a current serving cell, and the terminal equipment generates an RLF report. Exemplarily, the RLF report may include at least one of the following information:
   Information on a failed cell: the failed cell is a cell where the terminal equipment detects the connection failure. Cell information may include at least one of the following: a cell global identifier (CGI), a physical cell identifier (PCI) and frequency point information, a cell identifier (cell ID), a non-public network identifier (NPN ID), a non-terrestrial network identifier (NTN ID), or other cell identifier. The CGI may include a public land mobile network identifier (PLMN ID) and a cell ID. Optionally, the information on a failed cell may further include a tracking area code (TAC) and/or identifier information of a network device to which the failed cell belongs, such as a global network device identifier, etc. During a mobility procedure, the failed cell may also be called a target cell.
   Information on a previous serving cell: the previous serving cell is a primary cell (previous primary cell) from which a terminal equipment received a mobility command for a last time. During a mobility procedure, the previous serving cell may also be called a source cell.
   Failure type information: e.g., RLF, HOF.
   Connection failure time information: the connection failure time information may be used to indicate a time duration from when the terminal equipment received a handover command (or a reconfiguration message) for the last (most recent) time to when the terminal equipment detects the connection failure.
220: the terminal equipment transmits RLF report available indication information to an accessed network device (reception node), and the accessed network device may be called a receiving network device;
230: the terminal equipment receives an RLF report request transmitted by the receiving network device;
240: the terminal equipment transmits an RLF report to the receiving network device;
250: the receiving network device forwards the RLF report to a target network device.

As an example, the receiving network device determines, according to a failure type, a target network device that needs to forward the RLF report. For example,
If the failure type is a HOF, the receiving network device forwards the RLF report to a network device (e.g., a source base station in this handover process, SgNB) corresponding to a previous serving cell, for example forwards the RLF report via a failure indication message.
If the failure type is an RLF, the receiving network device forwards the RLF report to a network device corresponding to a failed cell (if the terminal equipment has not performed a handover procedure before this RLF, the network device is a base station gNB corresponding to a cell where the RLF occurs; or, if the terminal equipment has performed the handover procedure before this RLF, the network device is a target base station TgNB in a previous handover procedure), for example forwards the RLF report via a failure indication message. FIG. 2 takes that the terminal equipment has performed a handover procedure before this RLF as an example. It is understandable that if a network device (e.g., a target base station TgNB) corresponding to the failed cell determines that a mobility failure type is too early handover or handover to wrong cell, further, a network device corresponding to the failed cell forwards an RLF report to a network device (e.g., a source base station SgNB) corresponding to a previous serving cell, for example forwards the RLF report via a handover report message.

Embodiments of the present disclosure are described below in conjunction with the drawings and specific implementations. For ease of description, the following text takes a base station as an example of an access network device for description. In the following descriptions, without causing confusion, “if . . . ”, “in a case where . . . ” and “when . . . ” may be used interchangeably.

It is understandable that in embodiments of the present disclosure, the terminal equipment and/or the network device may perform some or all steps in embodiments of the present disclosure. These steps or operations are only examples, and embodiments of the present disclosure may further perform other operations or variations of various operations. In addition, steps may be performed in different orders presented in embodiments of the present disclosure, and it is possible that not all operations in embodiments of the present disclosure are performed.

### Embodiments of a First Aspect

Embodiments of the present disclosure provide a method for mobility management, which is described from a side of a first network device CU.

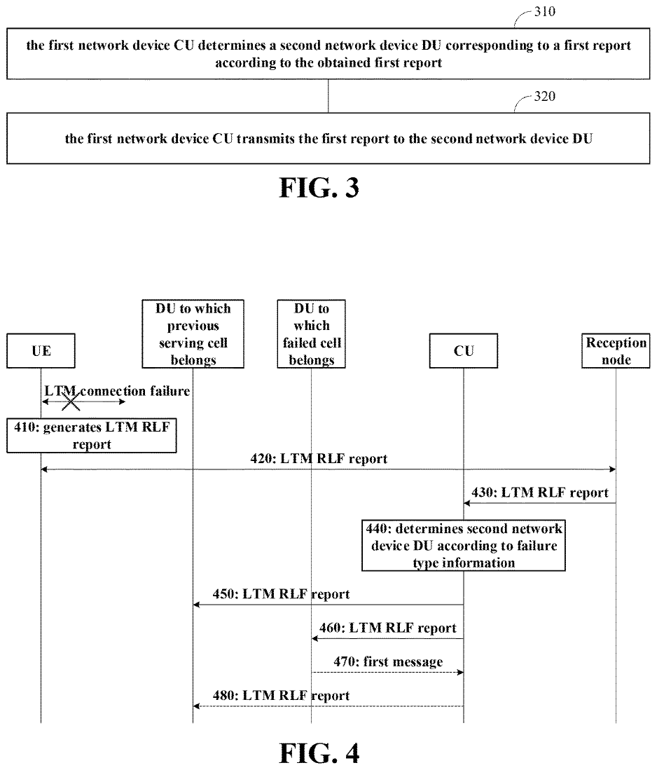

FIG. 3 is a schematic diagram of the method for mobility management in embodiments of the present disclosure, as shown in FIG. 3, the method includes:
310: the first network device CU determines a second network device DU corresponding to a first report according to the obtained first report; and
320: the first network device CU transmits the first report to the second network device DU.

In the embodiments of the present disclosure, the second network device DU is a device under the first network device CU.

It is worth noting that the above FIG. 3 only schematically describes embodiments of the present disclosure, however the present disclosure is not limited thereto. For example, some other operations may be added or certain operations therein may be reduced. Persons skilled in the art may make appropriate modifications according to the above contents, not being limited to records in the above FIG. 3.

According to the method in the above embodiments, that the first network device CU determines a forwarding mechanism of the first report is introduced, thereby under a CU-DU architecture, after receiving the first report, the first network device CU may forward the first report to a corresponding network device DU, so that the corresponding network device DU may perform corresponding parameter adjustments according to the first report, thereby LTM robustness is improved.

In embodiments of the present disclosure, the first report is a mobility report, and e.g. may include at least one of the following reports described above: a failure report, a successful mobility report, a random access report (RA report), a connection establishment failure report (CEF report), or other reports, etc., and for details, relevant technologies may be referred to.

In some embodiments, the first report includes failure type information, and the first network device CU may determine, according to the first report, that the first report is an LTM related report, and determine, according to the failure type information, the second network device DU corresponding to the first report, i.e., a target network device. For example, the first network device CU determines that a mobility procedure corresponding to the first report is LTM, and further determines, according to the failure type information in the first report, the second network device DU corresponding to the first report.

In the above embodiments, the second network device DU corresponding to the first report may be a network device DU to which a previous serving cell belongs in the first report, or may be a network device DU to which a failed cell belongs in the first report.

For example, if a failure type indicated by the failure type information is a HOF, the first network device CU determines that the second network device DU corresponding to the first report is a network device DU to which the previous serving cell belongs. At this point, the first network device CU transmits the first report to the network device DU to which the previous serving cell belongs.

In the above examples, the network device DU to which the previous serving cell belongs may be called a source DU, and the first network device CU may transmit the first report to the source DU via an access and mobility indication message, a failure indication message, or other message.

For another example, if a failure type indicated by the failure type information is an RLF, the first network device CU determines that the second network device DU corresponding to the first report is a network device DU to which the failed cell belongs. At this point, the first network device CU transmits the first report to the network device DU to which the failed cell belongs.

In the above examples, the first network device CU may transmit the first report to the network device DU to which the failed cell belongs via an access and mobility indication message, a failure indication message, or other message.

As one possible example, the first report may include first time information, the first time information being connection time information between the terminal equipment and a failed cell. For example, the first time information may be used to indicate a time duration from when the terminal equipment received a handover command (or a reconfiguration message, or an LTM mobility command (e.g. an LTM cell switch message)) for the last (most recent) time to when the terminal equipment detects a connection failure.

In the above examples, after receiving the first report, the network device DU to which the failed cell belongs determines that the first report is an LTM related report. If the first time information is not in the first report, or a time duration indicated by the first time information is greater than or equal to a first time threshold, the network device DU to which the failed cell belongs may optimize corresponding LTM mobility configuration information according to the first report, thereby robustness is improved.

As one example, the terminal equipment accesses the failed cell from a non-connected state, or hands over from a previous serving cell to the failed cell, has received configuration information of an LTM candidate cell transmitted from the failed cell, detects an RLF with the failed cell, the first time information is not in the first report, or a connection time between the terminal equipment and the failed cell in the first report (i.e., a time duration indicated by the first time information) is greater than or equal to a first time threshold. It is understandable that in the above scenario, the network device DU to which the failed cell belongs may optimize corresponding LTM mobility configuration information according to the first report.

In the above embodiments, the first time threshold is used to determine whether a current connection failure is caused by a relevant mobility configuration of the network device DU to which the failed cell belongs, and may be predefined by a protocol, or may be obtained by the network device DU from an OAM device, i.e., configured by the OAM device.

In the above embodiments, after receiving the first report, the network device DU to which the failed cell belongs determines that the first report is an LTM related report, and determines that a time duration indicated by the first time information is less than or equal to a second time threshold, the network device DU to which the failed cell belongs may transmit a message indicating a cause for the connection failure (called a first message) to the first network device CU.

As one example, the terminal equipment enters the failed cell from a previous serving cell via an LTM mechanism, detects an RLF with the failed cell, a connection time between the terminal equipment and the failed cell (a time duration indicated by the first time information) is less than or equal to a second time threshold. In the above scenario, the network device DU to which the failed cell belongs may transmit a first message to the first network device CU.

In the above embodiments, a definition of the second time threshold is the same as that of the first time threshold, and a value of the second time threshold may be the same as or different from a value of the first time threshold.

In the above embodiments, the first network device CU may receive the first message and determine a cause for the connection failure according to the first message.

As one possible implementation, the first message may include at least one of the following: a message type, interface identifier information of a terminal equipment on a CU-DU interface at a side of a network device DU to which the failed cell belongs, and interface identifier information of a terminal equipment on a CU-DU interface at a side of a first network device CU. The message type is used to uniquely identify the message. As one example, the first message may include at least one of a message type, a gNB-CU UE F1AP ID, or a gNB-DU UE F1AP ID.

As another possible implementation, the first message may include at least one of a message type, or service identifier information. The service identifier information is used to uniquely identify the procedure. As one example, the first message may include at least one of a message type, or a transaction ID.

In some implementations, the first message further includes at least one of the following:
the first report (e.g., an LTM RLF report);
first indication information for indicating a cause for an LTM connection failure;
information on the previous serving cell;
identifier information (e.g. a gNB-DU ID) of a DU to which the previous serving cell belongs;
name information (e.g. a gNB-DU name) of a DU to which the previous serving cell belongs;
identifier information of the terminal equipment in the previous serving cell;
mobility information of the terminal equipment; or
identifier information on mobility information of the terminal equipment.

In the above implementations, the first report is used for the first network device CU to forward the first report. As one possible implementation, if the first network device CU deletes the first report after transmitting the first report to a network device DU to which a failed cell belongs, by carrying the first report in a first message, it may be ensured that the first network device CU successfully retrieves the first report and forwards the first report to the corresponding network device DU.

In the above implementations, the first indication information is used to indicate the first network device CU that the current connection failure is not caused by the network device DU, or is used to indicate the first network device CU that the current connection failure is caused by other network device DU.

In the above implementations, the information on the previous serving cell is used for the first network device CU to determine a cell that needs to forward the first report and/or a network device DU (i.e., a source DU) to which the cell belongs.

In the above implementations, the identifier information of the terminal equipment in a previous serving cell may be a Cell Radio-Network Temporary Identifier (C-RNTI) of the terminal equipment in the previous serving cell, or interface identifier information of the terminal equipment on a CU-DU interface at a side of a network device DU to which the previous serving cell belongs, or other identifier information that may uniquely identify the terminal equipment in the previous serving cell or at a side of a network device DU to which the previous serving cell belongs.

In the above implementations, the mobility information of the terminal equipment is used to indicate configuration information of mobility parameters corresponding to the current connection failure, such as mobility information.

In the above implementations, the identifier information on mobility information of the terminal equipment is used to indicate identifier information of configuration information of mobility parameters corresponding to a current connection failure, such as a mobility information index or a mobility information identifier, which may be used to determine configuration information of corresponding mobility parameters.

As one example, the first message may be a failure transfer message, an LTM RLF report failure transfer message, a handover report message, or other message.

In the above embodiments, after receiving the first message, the first network device CU may further transmit the first report to a network device DU to which the previous serving cell belongs.

In the above embodiments, optionally, when the first network device CU receives the first message, the first network device CU may determine, according to information on the previous serving cell in the first report, a corresponding network device DU (source DU), thereby transmitting the corresponding first report to the source DU, so that the source DU may determine to adjust corresponding mobility configuration parameters based on the first report, thereby LTM robustness is improved.

As one example, the first network device CU may transmit the first report to the network device DU to which the previous serving cell belongs via an access and mobility indication message, a failure indication message, or other message.

In the above embodiments, the first network device CU determines that the first report is an LTM related report, and according to the failure type information, determines the second network device DU corresponding to the first report. Further, the second network device DU determines that the first report is an LTM related report, and according to the first time information, further determines whether it is needed to optimize corresponding LTM mobility configuration information according to the first report.

In some other embodiments, the first network device CU determines that the first report is an LTM related report, and the first network device CU may determine, according to the failure type information and the first time information, the second network device DU corresponding to the first report.

For example, if a failure type indicated by the failure type information is a handover failure (HOF), the first network device CU determines that the second network device DU corresponding to the first report is a network device DU to which a previous serving cell belongs. Thus, the first network device CU transmits the first report to the network device DU to which the previous serving cell belongs. It is understandable that in this scenario, the first network device CU may determine, according to the failure type information, the second network device DU corresponding to the first report.

For another example, if a failure type indicated by the failure type information is a radio link failure (RLF), and the first time information is not in the first report, or a time duration indicated by the first time information is greater than or equal to a third time threshold, the first network device CU determines that the second network device DU corresponding to the first report is a network device DU to which a failed cell belongs. Thus, the first network device CU transmits the first report to the network device DU to which the failed cell belongs. In this scenario, the first network device CU may determine, according to the failure type information and the first time information, the second network device DU corresponding to the first report.

For another example, if a failure type indicated by the failure type information is a radio link failure (RLF), and if the first time information is less than or equal to a fourth time threshold, the first network device CU determines that the second network device DU corresponding to the first report is a network device DU to which a previous cell belongs. Thus, the first network device CU transmits the first report to the network device DU to which the previous serving cell belongs. In this scenario, the first network device CU may determine, according to the failure type information and the first time information, the second network device DU corresponding to the first report. It is understandable that the first network device CU may further transmit at least one of the following information to the network device DU to which the previous serving cell belongs: identifier information of the terminal equipment in the previous serving cell, mobility information of the terminal equipment, or identifier information on mobility information of the terminal equipment.

In the above examples, definitions of the third time threshold and the fourth time threshold are the same as the definition of the first time threshold. Moreover, values of the third time threshold and the fourth time threshold may be the same or may be different. The third time threshold and/or the fourth time threshold may be preset by a protocol, or may be obtained by the first network device CU from an OAM device, i.e., configured by the OAM device, or may be obtained by the first network device CU from the second network device DU.

Methods in embodiments of the present disclosure are described below in conjunction with specific examples.

FIG. 4 is a schematic diagram of a forwarding process of the first report according to the method in embodiments of the present disclosure. In an example of FIG. 4, taking that the first report is an LTM RLF report as an example, and that the receiving network device and the first network device CU belong to different network devices as an example. As shown in FIG. 4, the process includes:
410: in an LTM mobility procedure, a terminal equipment detects a connection failure related to LTM, records and generates an LTM RLF report, the LTM RLF report including failure type information.
420: the terminal equipment transmits the LTM RLF report to a receiving network device (reception node);
430: the receiving network device transmits the LTM RLF report to a corresponding network device CU (called a first network device CU);
440: the network device CU determines a network device DU (called a second network device DU) corresponding to the LTM RLF report according to the failure type information; if the failure type information is a HOF, 450 is performed; if the failure type information is an RLF, 460 is performed;
450: the network device CU transmits the LTM RLF report to a network device DU to which a previous serving cell belongs;
460: the network device CU transmits the LTM RLF report to a network device DU to which a failed cell belongs;
470: the network device DU to which the failed cell belongs transmits a first message to the network device CU, the first message being used to indicate to the network device CU that a cause for the LTM connection failure is a problem of another network device DU; and
480: the network device CU transmits the LTM RLF report to the network device DU to which the previous serving cell belongs.

In operation 410, optionally, the LTM RLF report may further include at least one of information on a failed cell, first time information, or information on a previous serving cell. For descriptions of the failure type information, the information on a failed cell, the first time information, and information on a previous serving cell, reference may be made to descriptions in other embodiments of the present disclosure, details thereof are omitted here.

It is understandable that the LTM mobility procedure may refer to that the terminal equipment has received configuration information of an LTM candidate cell, and/or the terminal equipment has received an LTM cell change message.

In operation 420, only an operation result is described. Similar to the procedure in FIG. 2, operation 420 may be completed through the following three split operations, i.e.,:
Operation 420-1: the terminal equipment transmits, to an accessed network device, indication information in which an LTM RLF report is stored; the accessed network device is e.g. the receiving network device;
Operation 420-2: the terminal equipment receives request indication information for reporting the LTM RLF report, transmitted by the accessed network device; as one example, the request indication information may be carried in a terminal equipment (UE) information request message, however the present disclosure is not limited thereto.
Operation 420-3: the terminal equipment transmits the LTM RLF report to the receiving network device; as one example, the LTM RLF report may be carried in a terminal equipment (UE) information response message, however the present disclosure is not limited thereto.

In operation 430, the corresponding network device CU is a CU to which a previous serving cell belongs in the LTM RLF report, or a network device CU to which a failed cell belongs in the LTM RLF report. As one example, the receiving network device may transmit the LTM RLF report to the corresponding network device CU via a failure indication message or other message.

In operation 440, if the failure type information is a HOF, the network device CU determines that the corresponding second network device DU is a network device DU to which a previous serving cell belongs, and operation 450 is performed, i.e., the network device CU transmits the LTM RLF report to the network device DU to which the previous serving cell belongs. As one example, the network device CU may transmit the LTM RLF report to the network device DU to which the previous serving cell belongs via an access and mobility indication message, a failure indication message, or other message.

In operation 440, if the failure type information is an RLF, the network device CU determines that the corresponding second network device DU is a network device DU to which a failed cell belongs, and operation 460 is performed, i.e., the network device CU transmits the LTM RLF report to the network device DU to which the failed cell belongs. As one example, the network device CU may transmit the LTM RLF report to the network device DU to which the failed cell belongs via an access and mobility indication message, a failure indication message, or other message.

As one possible implementation, the network device CU determines that the LTM RLF report is an LTM related report, then performs operation 440.

As another possible implementation, operation 440 may be replaced by operation 440′, that is, the network device CU, according to that the LTM RLF report is an LTM related report and according to the failure type information, determines the network device DU (called a second network device DU) corresponding to the LTM RLF report. That is, “determining that the LTM RLF report is an LTM related report” and “determining a network device DU corresponding to the LTM RLF report” are performed in parallel and there exists no sequential order.

In operation 450, after the network device CU transmits the LTM RLF report to the network device DU to which the previous serving cell belongs, correspondingly, the network device DU to which the previous serving cell belongs may optimize corresponding LTM mobility configuration information according to the LTM RLF report, thereby robustness is improved.

It is understandable that the network device CU may further transmit at least one of the following information to the network device DU to which the previous serving cell belongs: identifier information of the terminal equipment in the previous serving cell, mobility information of the terminal equipment, or identifier information on mobility information of the terminal equipment.

In operation 460, after the network device CU transmits the LTM RLF report to the network device DU to which the failed cell belongs, correspondingly, the network device DU to which the failed cell belongs determines whether it is needed to optimize LTM mobility configuration information according to the LTM RLF report.

In one possible implementation, after receiving the LTM RLF report, the DU to which the failed cell belongs determines that the LTM RLF report is an LTM related report. Further, if the first time information is not in the LTM RLF report, or a time duration indicated by the first time information is greater than or equal to a first time threshold, the network device DU to which the failed cell belongs may optimize corresponding LTM mobility configuration information according to the LTM RLF report, thereby robustness is improved; if the time duration indicated by the first time information is less than or equal to a second time threshold, operations 470 and 480 are performed.

For descriptions of the first time information, the first time threshold, and the second time threshold, reference may be made to descriptions in other embodiments of the present disclosure, descriptions thereof are not repeated here.

In operation 470, for descriptions of the first message, reference may be made to descriptions in other embodiments of the present disclosure, descriptions thereof are not repeated here.

In operation 480, as one example, the network device CU may transmit the LTM RLF report to the network device DU to which the previous serving cell belongs via an access and mobility indication message, a failure indication message, or other message. For descriptions of that the network device CU transmits the LTM RLF report to the network device DU to which the previous serving cell belongs, reference may be made to descriptions in other embodiments of the present disclosure, descriptions thereof are not repeated here.

It is worth noting that in embodiments of the present disclosure, descriptions are made by taking that the receiving network device and the first network device CU belong to different network devices as an example, however the present disclosure does not impose limitations in this regard. If the receiving network device and the first network device CU belong to the same network device, the operation 430 may be understood as an internal operation of the network device, i.e., there is no need to perform the operation 430.

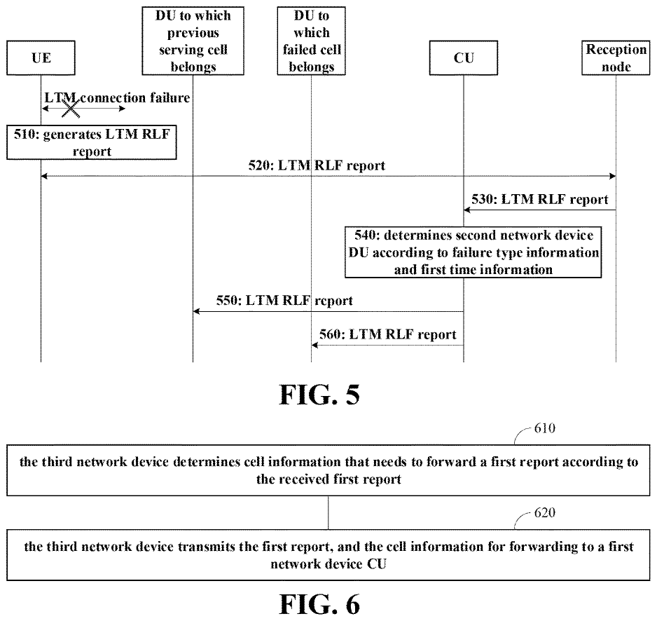

FIG. 5 is another schematic diagram of a forwarding process of the first report according to the method in embodiments of the present disclosure. In an example of FIG. 5, still taking that the first report is an LTM RLF report as an example, and that the receiving network device and the first network device CU belong to different network devices as an example. As shown in FIG. 5, the process includes:
510: in an LTM mobility procedure, a terminal equipment detects a connection failure related to LTM, records and generates an LTM RLF report, the LTM RLF report including failure type information and first time information;
520: the terminal equipment transmits the LTM RLF report to a receiving network device (reception node);
530: the receiving network device transmits the LTM RLF report to a corresponding network device CU (called a first network device CU);
540: the network device CU determines a network device DU (called a second network device DU) corresponding to the LTM RLF report according to the failure type information and/or the first time information; if the failure type information is a HOF, 550 is performed; if the failure type information is an RLF, 560 is performed;
550: the network device CU transmits the LTM RLF report to a network device DU to which a previous serving cell belongs; and
560: the network device CU transmits the LTM RLF report to a network device DU to which a failed cell belongs.

In operation 510, optionally, the LTM RLF report may further include at least one of information on a failed cell, or information on a previous serving cell. For descriptions of the failure type information, the information on a failed cell, the first time information, and information on a previous serving cell, reference may be made to descriptions in other embodiments of the present disclosure, details thereof are omitted here.

It is understandable that the LTM mobility procedure may refer to that the terminal equipment has received configuration information of an LTM candidate cell, and/or the terminal equipment has received an LTM cell change message.

Operations 520 to 530 and operations 550 to 560 are respectively the same as operations 420 to 430 and operations 450 to 460 shown in FIG. 4, and contents thereof are incorporated here and are not repeated here.

In operation 540, the network device CU determines the second network device DU according to the failure type information and/or the first time information included in an LTM RLF report.

For example, if a failure type indicated by the failure type information is a handover failure (HOF), the first network device CU determines that the second network device DU corresponding to the LTM RLF report is a network device DU to which a previous serving cell belongs, and the first network device CU performs operation 550.

For another example, if a failure type indicated by the failure type information is a radio link failure (RLF), and if the first time information is less than or equal to a fourth time threshold, the first network device CU determines that the second network device DU corresponding to the LTM RLF report is a network device DU to which a previous serving cell belongs, and the first network device CU performs operation 550.

For another example, if a failure type indicated by the failure type information is a radio link failure (RLF), and if the first time information is not in the LTM RLF report or the first time information is greater than or equal to a third time threshold, the first network device CU determines that the second network device DU corresponding to the LTM RLF report is a network device DU to which a failed cell belongs, and the first network device CU performs operation 560.

As one possible implementation, the network device CU determines that the LTM RLF report is an LTM related report, and the network device CU performs operation 540.

As another possible implementation, operation 540 may be replaced by operation 540′, that is, the network device CU, according to that the LTM RLF report is an LTM related report and according to the failure type information and/or the first time information, determines the network device DU (called a second network device DU) corresponding to the LTM RLF report. That is, “determining that the LTM RLF report is an LTM related report” and “determining, according to the failure type information and/or the first time information, a network device DU corresponding to the LTM RLF report” are performed in parallel and there exists no sequential order.

For descriptions of the first time information, the third time threshold, and the fourth time threshold, reference may be made to descriptions in other embodiments, descriptions thereof are not repeated here.

Each of the above embodiments only exemplarily describes a method in embodiments of the present disclosure, however the present disclosure is not limited thereto, and appropriate variation(s) may be further made based on each of the above embodiments. For example, each of the above embodiments may be used individually, or one or more of the above embodiments may be combined.

According to methods in embodiments of the present disclosure, that the first network device CU determines a forwarding mechanism of the first report is introduced, i.e., the first network device CU determines a corresponding network device DU according to the failure type information or according to the failure type information and/or the first time information, thereby under a CU-DU architecture, after receiving the first report, the first network device CU may forward the first report to a corresponding network device DU, so that the corresponding network device DU may perform corresponding parameter adjustments according to the first report, thereby LTM robustness is improved.

### Embodiments of a Second Aspect

Embodiments of the present disclosure provide a method for mobility management.

FIG. 6 is a schematic diagram of the method for mobility management in embodiments of the present disclosure, which is described from a third network device side. As shown in FIG. 6, the method includes:
610: the third network device determines cell information that needs to forward a first report according to the received first report; and
620: the third network device transmits the first report, and the cell information for forwarding to a first network device CU.

It is worth noting that the above FIG. 6 only schematically describes embodiments of the present disclosure, however the present disclosure is not limited thereto. For example, an execution step of operations may be adjusted appropriately, and other some operations may further be increased or certain operations therein may be reduced. Persons skilled in the art may make appropriate modifications according to the above contents, not being limited to records in the above FIG. 6.

According to the method in the above embodiments, that a receiving network device CU (called a third network device) determines a forwarding mechanism of the first report when the first report is an LTM related report is introduced, thereby under a CU-DU architecture, after receiving the first report, the first network device CU may forward the first report to a corresponding network device DU, so that the corresponding network device DU may perform corresponding parameter adjustments according to the first report, thereby LTM robustness is improved.

In the above embodiments, in operation 610, it is understandable that the third network device may determine, according to the first report, that the first report is an LTM related report, and may further determine, according to failure type information in the first report, cell information for forwarding.

In some embodiments, the first report includes failure type information, and the third network device determines, according to the failure type information, the cell information for forwarding the first report.

For example, if a failure type indicated by the failure type information is a HOF, the third network device determines that the cell information for forwarding the first report is information on a previous serving cell, and the third network device transmits the first report and the information on the previous serving cell (i.e., the cell information for forwarding is set to information on a previous serving cell) to the first network device CU.

For another example, if a failure type indicated by the failure type information is an RLF, the third network device determines that the cell information for forwarding the first report is information on a failed cell, and the third network device transmits the first report and the information on the failed cell (i.e., the cell information for forwarding is set to information on a failed cell) to the first network device CU.

According to the above embodiments, after receiving the first report and the cell information for forwarding, the first network device may transmit the first report to a second network device DU to which the cell information for forwarding belongs, according to the cell information for forwarding.

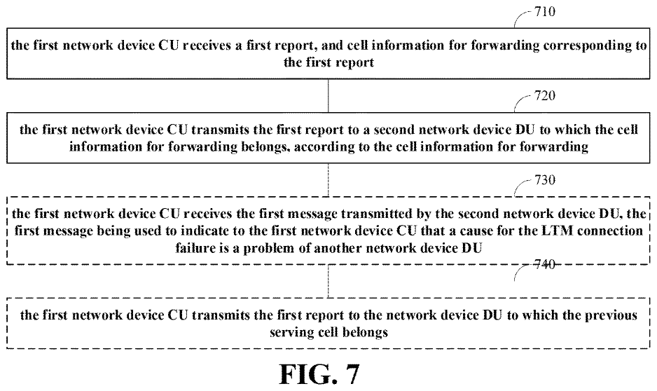

FIG. 7 is another schematic diagram of the method for mobility management in embodiments of the present disclosure, which is described from a side of a first network device CU. As shown in FIG. 7, the method includes:
710: the first network device CU receives a first report, and cell information for forwarding corresponding to the first report; and
720: the first network device CU transmits the first report to a second network device DU to which the cell information for forwarding belongs, according to the cell information for forwarding.

It is worth noting that the above FIG. 7 only schematically describes embodiments of the present disclosure, however the present disclosure is not limited thereto. For example, an execution step of operations may be adjusted appropriately, and other some operations may further be increased or certain operations therein may be reduced. Persons skilled in the art may make appropriate modifications according to the above contents, not being limited to records in the above FIG. 7.

In the above embodiments, as described above, the cell information for forwarding may be information on a previous serving cell, or may be information on a failed cell.

If the cell information for forwarding is information on a previous serving cell, the first network device CU may transmit the first report to a second network device DU to which the information on the previous serving cell belongs. As one example, the first network device CU may transmit the first report via an access and mobility indication message, a failure indication message, or other message.

If the cell information for forwarding is information on a failed cell, the first network device CU may transmit the first report to a second network device DU to which the information on the failed cell belongs. As one example, the first network device CU may transmit the first report via an access and mobility indication message, a failure indication message, or other message.

In the above embodiments, after receiving the first report, the second network device DU to which the information on the failed cell belongs may determine, according to the first report, whether it is needed to optimize LTM mobility configuration information. For specific implementations, reference may be made to descriptions of operation 460, details thereof are not repeated here. In the above embodiment, it is understandable that if a connection failure type is an RLF, the second network device DU may further transmit a first message to the first network device CU, the first message being used to indicate a cause for an LTM connection failure. In embodiments of the present disclosure, as shown in FIG. 7, the method may further include:
730: the first network device CU receives the first message transmitted by the second network device DU (the second network device DU to which the failed cell belongs), the first message being used to indicate to the first network device CU that a cause for the LTM connection failure is a problem of another network device DU.

For descriptions of the first message, reference may be made to descriptions in operation 470, descriptions thereof are not repeated here.
740: the first network device CU transmits the first report to the network device DU to which the previous serving cell belongs.

For descriptions of that the first network device CU transmits the first report to the network device DU to which the previous serving cell belongs, reference may be made to descriptions in operation 480, descriptions thereof are not repeated here.

In the above embodiments, as one possible implementation, the first message may include at least one of the following:
a message type;
interface identifier information of the terminal equipment at a side of a second network device DU to which the failed cell belongs; or
interface identifier information of the terminal equipment at a side of the first network device CU.

As one example, the first message may include at least one of a message type, a gNB-CU UE F1AP ID, or a gNB-DU UE F1AP ID.

In the above embodiments, as another possible implementation, the first message may include at least one of the following:
a message type; or traffic identifier information.

As one example, the first message may include at least one of a message type, or a transaction ID.

In the above two possible implementations, the first message may further include at least one of the following:
the first report;
first indication information for indicating a cause for an LTM connection failure;
the information on the previous serving cell;
identifier information (e.g. a gNB-DU ID) of a DU to which the previous serving cell belongs;
name information (e.g. a gNB-DU name) of a DU to which the previous serving cell belongs;
identifier information of the terminal equipment in the previous serving cell;
mobility information of the terminal equipment; or
identifier information on mobility information of the terminal equipment.

In the above embodiments, relevant contents of the first message have been described in embodiments of the first aspect, are incorporated here, and are not repeated here.

In the above embodiments, in operation 740, optionally, the first network device CU may determine, according to information on a previous serving cell in the first report, a corresponding network device DU (source DU), thereby transmitting the corresponding first report to the source DU, so that the source DU may determine to adjust corresponding mobility configuration parameters based on the first report, thereby LTM robustness is improved.

As one example, the first network device CU may transmit the first report to the network device DU to which the previous serving cell belongs via an access and mobility indication message, a failure indication message, or other message.

Methods in embodiments of the present disclosure are described below in conjunction with specific examples.

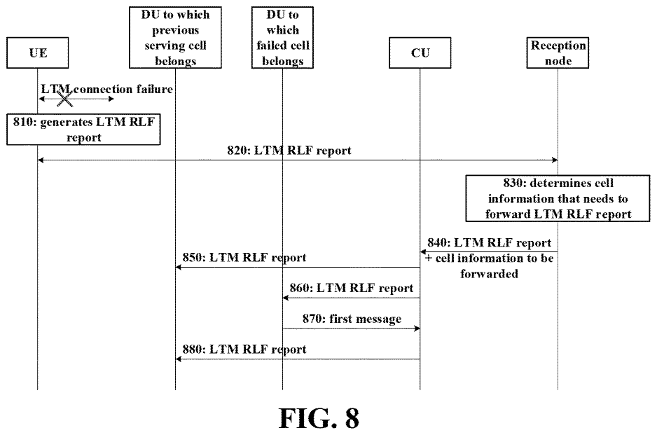

FIG. 8 is a schematic diagram of a forwarding process of the first report according to the method in embodiments of the present disclosure. In an example of FIG. 8, taking that the first report is an LTM RLF report as an example, and that a receiving network device and a first network device CU belong to different network devices as an example. As shown in FIG. 8, the process includes:
810: in an LTM mobility procedure, a terminal equipment detects a connection failure related to LTM, records and generates an LTM RLF report, the LTM RLF report including failure type information;
820: the terminal equipment transmits the LTM RLF report to a reception node (a third network device);
830: the reception node determines, according to the failure type information, cell information for forwarding the LTM RLF report;
840: the reception node transmits the LTM RLF report and the cell information for forwarding to a network device CU (a first network device CU);

For descriptions of the cell information for forwarding, reference may be made to descriptions in operation 710 and/or operation 720, descriptions thereof are not repeated here.

If the failure type information is a HOF, the reception node transmits the LTM RLF report and information on a previous serving cell to the network device CU, and the network device CU may perform operation 850; if the failure type information is an RLF, the reception node transmits the LTM RLF report and information on a failed cell to the network device CU, and the network device CU may perform operation 860.
850: the network device CU transmits the LTM RLF report to a network device DU to which a previous serving cell belongs;
860: the network device CU transmits the LTM RLF report to a network device DU to which a failed cell belongs;
870: the network device DU to which the failed cell belongs transmits a first message to the network device CU, the first message being used to indicate to the network device CU that a cause for the LTM connection failure is a problem of other network device DU; and
880: the network device CU transmits the LTM RLF report to the network device DU to which the previous serving cell belongs.

In the above examples, operations of 810 and 820 are the same as those of 410 and 420 in the embodiment shown in FIG. 4, and are not repeated here.

In operation 830, the reception node determines, according to the LTM RLF report, that the LTM RLF report is an LTM related report corresponding to a connection failure, and determines, according to the failure type information, cell information for forwarding the LTM RLF report (i.e., determines cell information for forwarding), that is, determines a mechanism that needs to forward the LTM RLF report.

In operation 840, if the failure type information is a HOF, the cell information for forwarding is information on a previous serving cell, the reception node transmits the LTM RLF report and information on the previous serving cell to the network device CU; and if the failure type information is an RLF, the cell information for forwarding is information on a failed cell, the reception node transmits the LTM RLF report and information on the failed cell to the network device CU.

In operation 850, optionally, the LTM RLF report further includes information on the previous serving cell, and the network device CU determines, according to the information on the previous serving cell, a network device DU to which it belongs, thereby transmitting the LTM RLF report to the corresponding network device DU. As one example, the network device CU may transmit the LTM RLF report to the corresponding network device DU via an access and mobility indication message, a failure indication message, or other message.

In operation 860, optionally, the LTM RLF report further includes information on the failed cell, and the network device CU determines, according to the information on the failed cell, a network device DU to which it belongs, thereby transmits the LTM RLF report to the corresponding network device DU. As one example, the network device CU may transmit the LTM RLF report to the corresponding network device DU via an access and mobility indication message, a failure indication message, or other message.

In operation 870, the network device DU to which the failed cell belongs transmits a first message to the network device CU. Relevant contents regarding the first message have been described in the preceding text and are not repeated here. For processing of operation 870, reference may be made to operation 470 in the embodiment of FIG. 4, and details are not repeated here.

In operation 880, the network device CU transmits the LTM RLF report to the network device DU to which the previous serving cell belongs. For processing of operation 880, reference may be made to operation 480 in the embodiment of FIG. 4, and details are not repeated here.

In operation 880, as one example, the network device CU may transmit the LTM RLF report to the network device DU to which the previous serving cell belongs via an access and mobility indication message, a failure indication message, or other message. Details have been described in the preceding text and are not repeated here.

Each of the above embodiments only exemplarily describes a method in embodiments of the present disclosure, however the present disclosure is not limited thereto, and appropriate variation(s) may be further made based on each of the above embodiments. For example, each of the above embodiments may be used individually, or one or more of the above embodiments may be combined.

According to the method in embodiments of the present disclosure, that the receiving network device determines a forwarding mechanism of the first report is introduced, thereby under a CU-DU architecture, after receiving the first report, the first network device CU may forward the first report to a corresponding network device DU, so that the corresponding network device DU may perform corresponding parameter adjustments according to the first report, thereby LTM robustness is improved.

### Embodiments of a Third Aspect

Embodiments of the present disclosure provide an apparatus for mobility management. The apparatus may be e.g. a network device, or may be one or more parts or components configured in a network device. Principles of the apparatus to solve problems are the same as those of the first network device CU in the method in embodiments of the first aspect, thus specific implementation thereof may refer to implementation of the method in embodiments of the first aspect, and the same contents are not repeated.

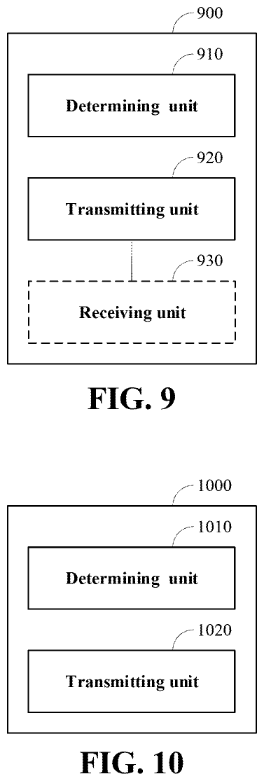

FIG. 9 is a schematic diagram of the apparatus for mobility management in embodiments of the present disclosure. As shown in FIG. 9, the apparatus 900 includes:
a determining unit 910 configured to determine a second network device DU corresponding to a first report according to the obtained first report; and
a transmitting unit 920 configured to transmit the first report to the second network device DU.

In some embodiments, the first report includes failure type information, and the determining unit 910 determines the second network device DU corresponding to the first report according to the failure type information.

For example, if a failure type indicated by the failure type information is a handover failure (HOF), the determining unit 910 determines that the second network device DU corresponding to the first report is a network device DU to which a previous serving cell belongs.

For another example, if a failure type indicated by the failure type information is a radio link failure (RLF), the determining unit 910 determines that the second network device DU corresponding to the first report is a network device DU to which a failed cell belongs.

In some embodiments, if the second network device DU corresponding to the first report is the network device DU to which the failed cell belongs, as shown in FIG. 9, the apparatus 900 further includes:
a receiving unit 930 configured to receive a first message transmitted by the network device DU to which the failed cell belongs, the first message being used to indicate a cause for an LTM connection failure.

In the above embodiments, as one possible implementation, the first message may include at least one of the following:
a message type;
interface identifier information of the terminal equipment at a side of the network device DU to which the failed cell belongs; or
interface identifier information of the terminal equipment at a side of the first network device CU.

In the above embodiments, as another possible implementation, the first message includes at least one of the following:
a message type; or
traffic identifier information.

In the above embodiments, optionally, the first message may further include at least one of the following:
the first report;
first indication information for indicating a cause for the LTM connection failure; information on the previous serving cell;
identifier information (e.g. a gNB-DU ID) of a DU to which the previous serving cell belongs;
name information (e.g. a gNB-DU name) of a DU to which the previous serving cell belongs;
identifier information of the terminal equipment in the previous serving cell;
mobility information of the terminal equipment; or
identifier information on mobility information of the terminal equipment.

In the above embodiments, the first indication information is used to indicate that the LTM connection failure is not caused by the network device DU to which the failed cell belongs, or is used to indicate that the LTM connection failure is caused by other network device DU(s).

In the above embodiments, identifier information of the terminal equipment in the previous serving cell includes one of the following:
a cell radio-network temporary identifier of the terminal equipment in the previous serving cell;
interface identifier information of the terminal equipment at a side of the network device DU to which the previous serving cell belongs; or
identifier information capable of uniquely identifying the terminal equipment at the previous serving cell or a side of the network device DU to which the previous serving cell belongs.

In the above embodiments, after the receiving unit 930 receives the first message, the transmitting unit 920 may further transmit the first report to the network device DU to which the previous serving cell belongs.

In some other embodiments, the first report further includes first time information, the first time information being used to indicate a connection time duration between the terminal equipment and the failed cell; and the determining unit 910 determines, according to the failure type information and the first time information, the second network device DU corresponding to the first report.

For example, if a failure type indicated by the failure type information is a handover failure (HOF), the determining unit 910 determines that the second network device DU corresponding to the first report is a network device DU to which the previous serving cell belongs.

For another example, if a failure type indicated by the failure type information is a radio link failure (RLF), and first time information is not in the first report, or the first time information is greater than or equal to a third time threshold, the determining unit 910 determines that the second network device DU corresponding to the first report is a network device DU to which the failed cell belongs.

For another example, if a failure type indicated by the failure type information is a radio link failure (RLF), and the first time information is less than or equal to a fourth time threshold, the determining unit 910 determines that the second network device DU corresponding to the first report is a network device DU to which the previous serving cell belongs.

The above text provides an exemplary description of embodiments of the present disclosure, but the present disclosure is not limited thereto, appropriate variation(s) may be further made based on each of the above embodiments. For example, each of the above embodiments may be used individually, or one or more of the above embodiments may be combined.

It is worth noting that the above text only describes components or modules related to the present disclosure, however the present disclosure is not limited thereto. The above apparatuses may further include other components or modules. For detailed contents of these components or modules, relevant technologies may be referred to. Moreover, each of the above components or modules may be implemented via a hardware facility such as a processor, a memory, a transmitter, a receiver, etc. Embodiments of the present disclosure have no limitation thereto.

According to apparatuses in embodiments of the present disclosure, that the first network device CU determines a forwarding mechanism of the first report is introduced, i.e., the first network device CU determines a corresponding network device DU according to the failure type information or according to the failure type information and/or the first time information, thereby under a CU-DU architecture, after receiving the first report, the first network device CU may forward the first report to a corresponding network device DU, so that the corresponding network device DU may perform corresponding parameter adjustments according to the first report, thereby LTM robustness is improved.

### Embodiments of a Fourth Aspect

Embodiments of the present disclosure provide an apparatus for mobility management.

FIG. 10 is another schematic diagram of the apparatus for mobility management in embodiments of the present disclosure. The apparatus may be a network device, or may be one or more parts or components configured in a network device. Principles of the apparatus to solve problems are the same as those of the third network device in the method in embodiments of the second aspect, thus specific implementation thereof may refer to implementation of the method in embodiments of the second aspect, and the same contents are not repeated.

As shown in FIG. 10, the apparatus 1000 includes:
a determining unit 1010 configured to determine cell information that needs to forward a first report according to the received first report; and
a transmitting unit 1020 configured to transmit the first report, and the cell information for forwarding to a first network device CU.

In some embodiments, the first report includes failure type information, and the determining unit 1010 determines, according to the failure type information, the cell information that needs to forward the first report.

For example, if a failure type indicated by the failure type information is a handover failure (HOF), the determining unit 1010 determines that the cell information that needs to forward the first report is information on a previous serving cell.

For another example, if a failure type indicated by the failure type information is a radio link failure (RLF), the determining unit 1010 determines that the cell information that needs to forward the first report is information on a failed cell.

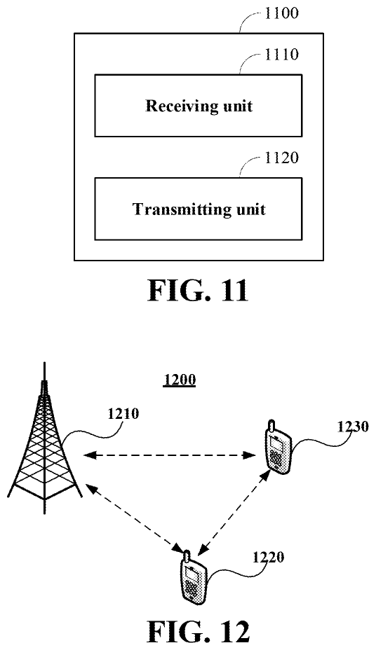

FIG. 11 is another schematic diagram of the apparatus for mobility management in embodiments of the present disclosure. The apparatus may be a network device, or may be one or more parts or components configured in a network device. Principles of the apparatus to solve problems are the same as those of the first network device CU in the method in embodiments of the second aspect, thus specific implementation thereof may refer to implementation of the method in embodiments of the second aspect, and the same contents are not repeated.

As shown in FIG. 11, the apparatus 1100 includes:
a receiving unit 1110 configured to receive a first report, and cell information for forwarding corresponding to the first report; and
a transmitting unit 1120 configured to transmit the first report to a second network device DU to which the cell information for forwarding belongs, according to the cell information for forwarding.

In embodiments of the present disclosure, the cell information for forwarding is information on a previous serving cell or information on a failed cell.

In some embodiments, if the cell information for forwarding is information on a previous serving cell, the transmitting unit 1120 transmits the first report to a second network device DU to which the previous serving cell belongs.

In some embodiments, if the cell information for forwarding is information on a failed cell, the transmitting unit 1120 transmits the first report to a second network device DU to which the failed cell belongs.

In the above embodiments, the receiving unit 1110 further receives a first message transmitted by a second network device to which the failed cell belongs, the first message being used to indicate a cause for an LTM connection failure.

In the above embodiments, in one possible implementation, the first message includes at least one of the following:
a message type;
interface identifier information of the terminal equipment at a side of a second network device DU to which the failed cell belongs; or
interface identifier information of the terminal equipment at a side of the first network device CU.

In the above embodiments, in another possible implementation, the first message includes at least one of the following:
a message type; or
traffic identifier information.

In the above embodiments, the first message may further include at least one of the following:
the first report;
first indication information for indicating a cause for the LTM connection failure;
information on the previous serving cell; identifier information (e.g. a gNB-DU ID) of a DU to which the previous serving cell belongs;
name information (e.g. a gNB-DU name) of a DU to which the previous serving cell belongs;
identifier information of the terminal equipment in the previous serving cell;
mobility information of the terminal equipment; or
identifier information on mobility information of the terminal equipment.

In the above embodiments, the first indication information is used to indicate that the LTM connection failure is not caused by the second network device DU to which the failed cell belongs, or is used to indicate that the LTM connection failure is caused by other network device DU(s).

In the above embodiments, the identifier information of the terminal equipment in the previous serving cell includes one of the following:
a cell radio-network temporary identifier of the terminal equipment in the previous serving cell;
interface identifier information of the terminal equipment at a side of a second network device DU to which the previous serving cell belongs; or
identifier information capable of uniquely identifying the terminal equipment at the previous serving cell or a side of the second network device DU to which the previous serving cell belongs.

In the above embodiments, after the receiving unit 1110 receives the first message, the transmitting unit 1120 may further transmit the first report to the second network device DU to which the previous serving cell belongs.

The above text provides an exemplary description of embodiments of the present disclosure, but the present disclosure is not limited thereto, appropriate variation(s) may be further made based on each of the above embodiments. For example, each of the above embodiments may be used individually, or one or more of the above embodiments may be combined.

It is worth noting that the above text only describes components or modules related to the present disclosure, however the present disclosure is not limited thereto. The above apparatuses may further include other components or modules. For detailed contents of these components or modules, relevant technologies may be referred to. Moreover, each of the above components or modules may be implemented via a hardware facility such as a processor, a memory, a transmitter, a receiver, etc. Embodiments of the present disclosure have no limitation thereto.

According to apparatuses in embodiments of the present disclosure, that the receiving network device determines a forwarding mechanism of the first report is introduced, thereby under a CU-DU architecture, after receiving the first report, the first network device CU may forward the first report to a corresponding network device DU, so that the corresponding network device DU may perform corresponding parameter adjustments according to the first report, thereby LTM robustness is improved.

### Embodiments of a Fifth Aspect

Embodiments of the present disclosure further provide a communication system, including a network device and a terminal equipment.

FIG. 12 is a schematic diagram of the communication system in embodiments of the present disclosure, schematically describing a situation by taking the terminal equipment and the network device as an example, and as shown in FIG. 12, the communication system 1200 may include the network device 1210 and the terminal equipments 1220, 1230. For simplicity, FIG. 12 only takes two terminal equipments and one network device as an example for description, however embodiments of the present disclosure are not limited thereto.

In embodiments of the present disclosure, transmission of existing services or future implementable services may be performed between the network device 1210 and terminal equipments 1220, 1230. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 12 shows that two terminal equipments 1220 and 1230 are within a coverage range of the network device 1210, however the present disclosure is not limited thereto. Two terminal equipments 1220 and 1230 may be not within the coverage range of the network device 1210, or one terminal equipment 1220 is within the coverage range of the network device 1210 while the other terminal equipment 1230 is outside the coverage range of the network device 1210.

In some embodiments, the network device includes the apparatus 900 in embodiments of the third aspect, as the first network device CU, configured to perform the method in embodiments of the first aspect. Since the method has been described in details in embodiments of the first aspect, contents thereof are incorporated here and are not repeated.

In some other embodiments, the network device includes the apparatus 1000 or 1100 in embodiments of the fourth aspect, as the third network device (i.e., a receiving network device) or the first network device CU, configured to perform the method in embodiments of the second aspect. Since the method has been described in details in embodiments of the second aspect, contents thereof are incorporated here and are not repeated.

Embodiments of the present disclosure further provide a network device, the network device may be e.g. a base station, such as a gNB under an intra-DU mobility scenario or an inter-DU mobility scenario, however the present disclosure is not limited thereto, the network device may further be other network device.

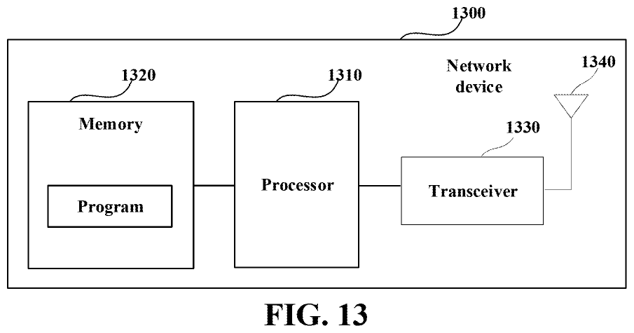

FIG. 13 is a schematic diagram of composition of the network device in embodiments of the present disclosure. As shown in FIG. 13, the network device 1300 may include: a processor 1310, and a memory 1320 coupled to the processor 1310. The memory 1320 may store various data; moreover, further stores a program for information processing, and executes the program under control of the processor 1310.

In some embodiments, functions of the apparatus 900 in embodiments of the third aspect or the apparatuses 1000 and 1100 in embodiments of the fourth aspect may be integrated into the processor 1310, wherein the processor 1310 may be configured to execute a program to implement the method described in embodiments of the first or second aspect, the contents of which are incorporated herein and are not described repeatedly here.

In some other embodiments, the apparatus 900 in embodiments of the third aspect or the apparatuses 1000 and 1100 in embodiments of the fourth aspect may be configured separately from the processor 1310, for example the apparatus 900 in embodiments of the third aspect or the apparatuses 1000 and 1100 in embodiments of the fourth aspect may be configured as a chip connected to the processor 1310, functions of the apparatus 900 in embodiments of the third aspect or the apparatuses 1000 and 1100 in embodiments of the fourth aspect are realized through the control of the processor 1310.

In addition, as shown in FIG. 13, the network device 1300 may further include: transceivers 1330 and 1340. Functions of the above components are similar to related arts, and are not further elaborated here. It is worth noting that the network device 1300 does not have to include all components shown in FIG. 13. Moreover, the network device 1300 may further include components not shown in FIG. 13, related arts may be referred to.

Embodiments of the present disclosure further provide a computer program, wherein when the program is executed in a network device, the program enables the network device to execute the method described in embodiments of the first or second aspect.

Embodiments of the present disclosure further provide a storage medium in which a computer program is stored, wherein the computer program enables a network device to execute the method described in embodiments of the first or second aspect.

Apparatuses and methods in the present disclosure may be implemented by hardware, or may be implemented by combining hardware with software. The present disclosure relates to such a computer readable program that when the program is executed by a logic component, the logic component is able to implement apparatuses described in the above text or a constituent component, or the logic component is able to implement various methods or steps described in the above text. The present disclosure further relates to a storage medium storing the above programs, such as a hard disk, a magnetic disk, an optical disk, a DVD, a flash memory and the like.

Methods/apparatuses described by combining with embodiments of the present disclosure may be directly embodied as hardware, a software module executed by a processor, or a combination of the two. For example, one or more of functional block diagrams shown in drawings or one or more combinations of functional block diagrams may correspond to software modules of a computer program process, or may correspond to hardware modules. These software modules may respectively correspond to steps shown in drawings. These hardware modules may be implemented by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM, or any other form of storage medium known in the art. A storage medium may be coupled to a processor, thus enabling the processor to read information from the storage medium and write information into the storage medium, or the storage medium may be a constituent part of a processor. A processor and a storage medium may be located in an ASIC. The software module may be stored in a memory of a mobile terminal, or may be stored in a memory card that may be inserted into a mobile terminal. For example, if a device (e.g., a mobile terminal) adopts a MEGA-SIM card with a larger capacity or a flash memory apparatus with a large capacity, the software module may be stored in the MEGA-SIM card, or in the flash memory apparatus with a large capacity.

One or more of functional block diagrams described in drawings or one or more combinations of functional block diagrams may be implemented as a general-purpose processor for performing functions described in the present disclosure, a digital signal processor (DSP), an application-specific integrated circuit (ASIC), a field-programmable gate array (FPGA) or other programmable logic device, a discrete gate or a transistor logic device, a discrete hardware component, or any appropriate combination thereof. One or more of functional block diagrams described in drawings or one or more combinations of functional block diagrams may further be implemented as a combination of computing devices, such as a combination of a DSP and a microprocessor, a plurality of microprocessors, one or more microprocessors combined and communicating with a DSP, or any other such configuration.

The present disclosure is described above by combining with specific implementations, however persons skilled in the art should clearly know that these descriptions are exemplary and do not limit protection scopes of the present disclosure. Persons skilled in the art may make various variations and amendments to the present disclosure according to spirits and principles of the present disclosure, these variations and amendments are also within scopes of the present disclosure.

As for implementations including the above embodiments, the following supplements are further disclosed:
1. A method for mobility management, wherein the method includes that:
   a third network device determines cell information that needs to forward a first report according to the received first report; and
   the third network device transmits the first report, and the cell information for forwarding to a first network device CU.
2. The method according to supplement 1, wherein,
   the first report includes failure type information, and the third network device determines, according to the failure type information, the cell information that needs to forward the first report.
3. The method according to supplement 2, wherein,
   if a failure type indicated by the failure type information is a handover failure (HOF), the third network device determines that the cell information that needs to forward the first report is information on a previous serving cell; and
   if a failure type indicated by the failure type information is a radio link failure (RLF), the third network device determines that the cell information that needs to forward the first report is information on a failed cell.
4. A method for mobility management, wherein the method includes that:
   a first network device CU receives a first report, and cell information for forwarding corresponding to the first report; and
   the first network device CU transmits the first report to a second network device DU to which the cell information for forwarding belongs, according to the cell information for forwarding.
5. The method according to supplement 4, wherein,
   the cell information for forwarding is information on a previous serving cell or information on a failed cell;
   if the cell information for forwarding is the information on the previous serving cell, the first network device CU transmits the first report to a second network device DU to which the previous serving cell belongs; and
   if the cell information for forwarding is the information on the failed cell, the first network device CU transmits the first report to a second network device DU to which the failed cell belongs.
6. The method according to supplement 5, wherein the method further includes that:
   the first network device CU receives a first message transmitted by the second network device to which the failed cell belongs, the first message being used to indicate a cause for an LTM connection failure.
7. The method according to supplement 6, wherein,
   the first message includes at least one of the following: a message type;
   interface identifier information of a terminal equipment at a side of the second network device DU to which the failed cell belongs; or
   interface identifier information of a terminal equipment at a side of the first network device CU;
   or, the first message includes at least one of the following:
   a message type; or
   traffic identifier information.
8. The method according to supplement 6 or 7, wherein the first message further includes at least one of the following:
   the first report;
   first indication information for indicating a cause for an LTM connection failure; information on the previous serving cell;
   identifier information (e.g. a gNB-DU ID) of a DU to which the previous serving cell belongs;
   name information (e.g. a gNB-DU name) of a DU to which the previous serving cell belongs;
   identifier information of a terminal equipment in the previous serving cell;
   mobility information of a terminal equipment; or
   identifier information on mobility information of a terminal equipment.
9. The method according to supplement 8, wherein,
   the first indication information is used to indicate that the LTM connection failure is not caused by the second network device DU to which the failed cell belongs, or is used to indicate that an LTM connection failure is caused by other network device DU(s);
   the identifier information of the terminal equipment in the previous serving cell includes one of the following:
   a cell radio-network temporary identifier of the terminal equipment in the previous serving cell;
   interface identifier information of the terminal equipment at a side of a second network device DU to which the previous serving cell belongs; or
   identifier information capable of uniquely identifying the terminal equipment at the previous serving cell or a side of a second network device DU to which the previous serving cell belongs.
10. The method according to supplement 6, wherein the method further includes that:
   the first network device CU further transmits the first report to the second network device DU to which the previous serving cell belongs.

What is claimed is

1. An apparatus for mobility management, configured in a first network device CU (Central Unit), the apparatus comprising:
processor circuitry configured to determine a second network device DU (Distributed Unit) corresponding to a first report according to the obtained first report, the second network device DU being a network device DU to which a previous serving cell belongs; and
a transmitter configured to transmit the first report to the second network device DU via access and mobility indication message.

2. The apparatus according to claim 1, wherein,
the first report comprises failure type information, and the first network device CU determines the second network device DU corresponding to the first report according to the failure type information.

3. The apparatus according to claim 2, wherein,
if a failure type indicated by the failure type information is a handover failure (HOF), the processor circuitry determines that the second network device DU corresponding to the first report is the network device DU to which the previous serving cell belongs; and
if a failure type indicated by the failure type information is a radio link failure (RLF), the processor circuitry determines that the second network device DU corresponding to the first report is a network device DU to which a failed cell belongs.

4. The apparatus according to claim 3, the apparatus further comprising:
a receiver configured to receive a first message transmitted by a network device DU to which the failed cell belongs if the second network device DU corresponding to the first report is the network device DU to which the failed cell belongs, the first message being used to indicate a cause for L1/L2 triggered mobility (LTM) connection failure.

5. The apparatus according to claim 4, wherein the first message comprises at least one of the following:
a message type;
interface identifier information of a terminal equipment at a side of a network device DU to which the failed cell belongs; or
interface identifier information of a terminal equipment at a side of the first network device CU.

6. The apparatus according to claim 4, wherein the first message comprises at least one of the following:
a message type; and
traffic identifier information.

7. The apparatus according to claim 4, wherein the first message comprises at least one of the following:
the first report;
first indication information for indicating a cause for an LTM connection failure;
information on the previous serving cell;
identifier information of a DU to which the previous serving cell belongs;
name information of a DU to which the previous serving cell belongs;
identifier information of a terminal equipment in the previous serving cell;
mobility information of a terminal equipment; or
identifier information on mobility information of a terminal equipment.

8. The apparatus according to claim 7, wherein,
the first indication information is used to indicate that the LTM connection failure is not caused by the network device DU to which the failed cell belongs, or is used to indicate that the LTM connection failure is caused by other network device DU(s).

9. The apparatus according to claim 7, wherein the identifier information of the terminal equipment in the previous serving cell comprises one of the following:
a cell radio-network temporary identifier of the terminal equipment in the previous serving cell;
interface identifier information of the terminal equipment at a side of a network device DU to which the previous serving cell belongs; or
identifier information capable of uniquely identifying the terminal equipment at a previous serving cell or a side of a network device DU to which the previous serving cell belongs.

10. The apparatus according to claim 4, wherein,
the transmitter further transmits the first report to the network device DU to which the previous serving cell belongs.

11. The apparatus according to claim 2, wherein,
the first report further comprises first time information, the first time information being used to indicate a connection time duration between a terminal equipment and a failed cell; and
the processor circuitry determines the second network device DU corresponding to the first report according to the failure type information and the first time information.

12. The apparatus according to claim 11, wherein,
if a failure type indicated by the failure type information is a HOF, the processor circuitry determines that the second network device DU corresponding to the first report is the network device DU to which the previous serving cell belongs; and
if a failure type indicated by the failure type information is an RLF,
if the first time information is greater than or equal to a third time threshold, the processor circuitry determines that the second network device DU corresponding to the first report is a network device DU to which a failed cell belongs; and
if the first time information is less than or equal to a fourth time threshold, the processor circuitry determines that the second network device DU corresponding to the first report is the network device DU to which the previous serving cell belongs.

13. A network device, comprising:
a memory configured to store a computer readable instruction, and;
processor circuitry configured to execute the computer readable instruction to perform:
determining a second network device DU corresponding to a first report according to the obtained first report, the second network device DU being a network device DU to which a previous serving cell belongs; and
transmitting the first report to the second network device DU via access and mobility indication message.

14. A communication system, comprising:
a terminal equipment, and;
the network device according to claim 13.
